(19) United States
(12) Patent Application Publication
(10) Pub. No.: US 2015/0204311 A1
(43) Pub. Date: Jul. 23, 2015

(54) CFRP RESISTIVE SHEET HEATING

(71) Applicant: Wobben Properties GmbH, Aurich (DE)

(72) Inventor: Christian Clemens, Berlin (DE)

(21) Appl. No.: 14/419,441

(22) PCT Filed: Aug. 6, 2013
(86) PCT No.: PCT/EP2013/066487

§ 371 Date: Feb. 3, 2015

(30) Foreign Application Priority Data
Aug. 6, 2012 (DE) 10 2012 015 540.9
May 31, 2013 (DE) 10 2013 210 205.4

(51) Int. Cl. F03D 11/00; H01T 4/08; H01T 4/02; F01D 5/14

(52) U.S. Cl. CPC F03D 11/0025; F01D 5/147; H01T 4/08; H01T 4/02

(57) ABSTRACT

The invention relates to a rotor blade of a wind power installation comprising a heating device for heating the rotor blade, arranged in the rotor blade in the area of its rotor blade surface, wherein the heating device has electrically conductive heating wires, and the heating wires run in a sinusoidal, wave-like and/or zigzag-shaped way, with an amplitude, defining a sinusoidal amplitude, wave height or respectively spike height, and a wavelength defining a period length, wavelength or respectively a distance between spikes, wherein the amplitude and/or wavelength varies along the heating wires in order to be able to adjust the specific areal heating performance of the heating device for each section.

### BACKGROUND

1. Technical Field

The invention relates to a heatable rotor blade of a wind power installation. The invention relates further to a method for heating a rotor blade of a wind power installation and the invention concerns a wind power installation. In addition, the present invention relates to a surge protector to be set up within a rotor blade and the invention concerns a heating device for heating a rotor blade. Furthermore, the invention relates to a method for designing a heating device.

2. Description of the Related Art

At temperatures below 0° C. or slightly above, icing can occur on the rotor blades of wind power installations. According to prior art, this problem is countered by rotor blade heating systems. A process for de-icing a rotor blade of a wind power installation is known from EP 0842360. This process is based on the object of finding a process for preventing the disadvantages resulting from the icing of the rotor blades that is simple from a construction point of view and therefore cost-efficient, yet also effective. In accordance with said document, this problem is solved by directing a pre-heated heat-transfer medium, which has flowed through a cavity located along the leading edge of the blade and given off heat to regions of the blade wall accordingly, into a cavity located along the trailing edge of the blade and conveying it out of said latter cavity. After the warm air has been fed in at the root of the blade, it cools down along the longitudinal axis of the blade (blade radius). This has the disadvantage that the de-icing effect is already significantly reduced in the place where most icing occurs, i.e., at the tip of the blade.

### BRIEF SUMMARY

One or more embodiments of the present invention may address at least one of the problems mentioned above and provide heating performance that is adapted to the respective position along the rotor blade. At least one alternative solution shall be proposed.

According to an embodiment of the invention, a rotor blade including a heating device is proposed. The heading device is located in an area of a surface of the rotor blade and heats the rotor blade. In one embodiment, the heating device is located in an outer shell of the rotor blade. To this end, the heating device can be integrated into the outer shell; in the case of an outer shell made of fiber-reinforced plastic, in particular, it can be laminated into this material. Furthermore, it can also be mounted directly to the inside of the outer shell, e.g., glued down on it, covering a wide area.

The heating device comprises heating wires and the heating wires have a sinusoidal, wave-like and/or zigzag-shaped design. In particular, the design can be described on the basis of a sinusoidal wave, which will be partially done in the following. However, the effects described and utilized in this context are not restricted to a sine wave according to a strictly mathematical understanding. The decisive aspect is that the heating wires are not arranged in a directly straight or respectively straightened manner, but deviate from such linear arrangement, particularly in a straight line, due to their sinusoidal, wave-like or zigzag-shaped design. Due to this design, each heating wire is thus also designed as a strip and therefore as an area, instead of being merely arranged along a line. This strip or respectively this area is arranged in parallel to the rotor blade surface in the respective area. With regard to the sine wave, this means that it oscillates in parallel to the blade surface.

A sine function has an amplitude and a period length. In addition to a phase position, which is of minor relevance in this context, these values characterize a sine wave. In a similar way, an amplitude characterizes the wave height in the case of a wave-like arrangement and an amplitude characterizes the spike height in the case of a zigzag-shaped pattern. The period length describes the distance from one peak value to the next, or the distance from one zero-crossing to the second next zero-crossing. Accordingly, the wavelength also describes the distance between two wave peaks in the case of a wave-like design, or respectively the distance between two neighboring spikes in the case of a zigzag-shaped design. For the purpose of this document, the term wavelength is used herein for the sinusoidal design, the wave-like design and also for the zigzag-shaped design fur summarization and unification purposes.

It is now proposed that the amplitude and/or wavelength vary along the heating wires in order to be able to gradually adjust a specific areal heating performance of the heating device for each section.

This proposal is based, in particular, on the idea that through the variation of the amplitude and/or wavelength, while the distance between the starting point and the end point of the respective heating wire remains the same, the length of the heating wire, which is effective for the heating, is nevertheless extended and that, therefore, the heating performance of this distance between said starting and end points is increased.

The heating wires are electroconductive and are supplied for heating with the respective electrical heating current. In accordance with Kirchhoff s junction rule, the heating current is the same along each heating wire and therefore leads to the same heating performance in all sections of the heating wire that have the same length. Through a reduction of the wavelength, several sections of the heating wire that have the same length can be located in the same area, which leads to an increase of the heating performance of this area. Thus, through this, the specific areal heating performance is increased. In principle, such an increase can also be achieved through an increase of the amplitude, which, however, with regard to an individual heating wire, would first of all lead to a wider area, through which the respective heating wire would have to run. When a number of heating wires arranged in parallel and basically oscillating in phase is used, an increase of the amplitude can be achieved with only a small widening of the heating strip where these heating wires are located.

Preferably, the amplitude and the wavelength respectively run in parallel to the rotor blade surface. Thus, the heating wires form a wide-area arrangement and this wide-area arrangement is parallel to the rotor blade surface and located in its vicinity, where it can heat the rotor blade surface in a targeted manner. It has to be taken into account that the heating serves the purpose of preventing or removing icing. Thus, the heating performance is needed on the rotor blade surface.

Preferably, the heating wires run in the longitudinal direction of the rotor blade. Thus, the heating wires can first of all be installed in the direction from the root of the blade to the tip of the blade and can accordingly span long areas of the rotor blade. Due to the arrangement in the direction of the longitudinal axis of the rotor blade, a variation of the specific areal heating performance in the longitudinal direction of the rotor blade can be achieved through the variation of the wavelength, in particular. Thus, through the suggested variation of the specific areal heating performance in the longitudinal direction of the rotor blade, the fact that especially strong icing can be expected in the area of the tip of the rotor blade can be accommodated for. The specific heating performance can now be simply adapted locally, i.e., in relation to the position along the rotor blade.

It is also suggested that, preferably, the heating wires have a constant wavelength and/or a smaller amplitude towards the tip of the rotor blade.

The specific areal heating performance is preferably set via the selection of the respective distance between neighboring heating wires, the selection of the wavelength of the heating wires and the selection of the amplitude of the heating wires.

It is also an advantage that a reduced amplitude can be compensated for by a reduction of the wavelength. If, for example, due to a reduced availability of space, a reduction of the amplitude is required, this could lead to a reduction of the specific areal heating performance, which, in turn, could be increased by a reduction of the wavelength in order to create a balance.

According to an embodiment, it is suggested that the heating wires be integrated into the rotor blade as carbon fibers and/or carbon fiber roving. Such a design is, in particular, suggested when, at least in the area of its outer shell, the rotor blade is made of fiber-reinforced plastic, in particular carbon-fiber-reinforced plastic (CFRP). In such case, the carbon fibers or carbon fiber rovings are adapted to the use in such material or respectively in such a structure. The design of the outer shell can therefore be restricted to known materials.

However, it has to be considered that the heating wires can practically not make any contribution to the stability of the rotor blade, since they are not arranged in a straight line. Therefore, the stability and thus the design for the stability of the rotor blade is independent from these heating wires. This simplifies the design.

Thus, the heating wires made of carbon fiber or carbon fiber roving can be arranged in a simple manner and they form a material that is very suitable for functioning as electrical heating resistance, since, in simple terms, they have an electric conductivity, which, however, is comparably low, at least in comparison with common metal conductors.

According to an embodiment, it is proposed that the heating wires be divided into heating groups of several heating wires connected in parallel and that several heating groups be connected between each other in series. According to this embodiment, several, and in most cases even a large number of, heating wires in a group are parallel to each other and are electrically connected in parallel as well by being electrically interconnected at a shared starting node and a shared end node. Preferably, the heating wires of a heating group are also parallel to each other with regard to their sinusoidal, wave-like or zigzag shape, in particular for example in phases.

Several of these heating groups are electrically connected in series, and are also arranged in a row, in particular along the longitudinal axis of the rotor blade. Due to this series connection, the same current flows through each heating group. If each heating group also comprises the same number of heating wires, which also have the same electrical values within the heating group, the same current will flow through each heating wire, too. Through the change or respectively varying selection of the wavelength of the heating wires for the different heating groups, a different, specific areal heating performance can be set for each of these heating groups. Nevertheless, or, in the alternative, through this, the specific areal heating performance can be varied within a heating group.

In fact, this variation of the amplitude and/or the wavelength along the longitudinal axis of the rotor blade makes a continuous or respectively stepless setting of the respectively desired specific areal heating performance possible. This can be performed irrespective of the specific connection in heating groups or otherwise, and is solely made possible through the variation of the wavelength and/or amplitude.

Preferably, the heating device—in its entirety or respectively group by group—is arranged in circumferential direction around the rotor blade, namely around the rotor blade axis. Thus, according to this embodiment, a division of the heating device and/or the heating groups in circumferential direction is avoided. For this design, too, the heating device is preferably integrated into the blade shell, in particular laminated into it.

However, according to an embodiment, different amplitudes and/or different wavelengths can be consistently required for different heating groups, for example in order to simplify structuring. If the heating current is set, the assignment of a specific wavelength and a specific amplitude to a specific heating group makes it possible to assign the respective specific areal heating performance to the heating group.

Another embodiment proposes that the rotor blade comprise an electrical lightning protection system to deflect a lightning strike. To this end, it is specified that the heating device is coupled with the lightning protection system via spark gaps or other high-voltage protection systems or respectively surge protectors in such way that galvanic isolation will be provided for as long as no lightning strikes the rotor blade and so that the surge protector or respectively spark gaps are passed or respectively skipped by the electric current if, through a lightning strike into the rotor blade, an electric current is induced in the heating device. Thus, the heating device is coupled with the lightning protection system, but galvanically isolated from it in normal operation. Therefore, the connection to the lightning protection system does not influence the normal operation of the heating device.

Such a surge protector can, for example, take the form of a respectively dimensioned diode or a varistor or respectively contain such elements. Partially depending on the direction of the current, such elements are only conductors when a certain voltage is exceeded and also have a very high electrical resistance, which, in this case, is also referred to as galvanically non-conductive. The surge protector deflects high voltage and is therefore a high-voltage protection and the term high-voltage protection will be used as a synonym for surge protector in the present application. A possible embodiment of the surge protector is a spark gap, which, in this context, will be described as representative of a variety of surge protectors (also of the ones not mentioned).

If lightning strikes the rotor blade, an equipotential bonding can be performed through these spark gaps, if need be. Such equipotential bonding is particularly necessary when lightning strikes the rotor blade, leads to a high current in the lightning protection system and thus induces a voltage in the heating device, in particular in the heating wires. For the protection of the heating device, in particular, this voltage should be deflected or respectively equalized, for which the spark gaps or respectively other high-voltage protection systems are required.

According to an embodiment, it is proposed that a surge protector, in particular a spark gap for coupling the heating device with the lightning protection system, be located at the start and at the end of the heating device and between each heating group respectively. Through this, a high voltage over the entire length of the heating device, which would be induced in case of a lightning strike, will be avoided, since, through the spark gaps, equipotential bonding is already achieved in the areas in between, namely, between the heating groups. The maximum voltage occurring in this context is restricted for each heating group to exactly the same voltage that would be induced in the respective heating group before the voltage sparks over at a spark gap.

Preferably, the rotor blade comprises a blade root and a blade tip and the heating device is divided into two sections that are connected in series. The first one of these sections runs from the blade root to the blade tip, and the second one runs back from the blade tip to the blade root. Now, these two sections can simply be connected to a power supply in the area of the blade root in order to provide the heating current in said area. Thus, expressed in a simplified manner, the heating current flows through the first section to the blade tip and through the second section back from the blade tip. Alternatively, it is also possible to direct a supply line from the blade root to the blade tip, if the heating device is not divided into the described sections or similar sections.

In addition, according to another embodiment of the invention, a wind power installation comprising a rotor with at least one rotor blade is proposed. Usually, however, three rotor blades are provided. This wind power installation is characterized in that its rotor blades have a heating device, and are, in particular, designed in such a way as described above according to at least one embodiment. Thus, the wind power installation can be made usable in an effective manner, even for situations where icing can occur.

In addition, according to yet another embodiment of the invention, a surge protector, in particular a spark gap, which is prepared to create a coupling between the electrical lightning protection system of a rotor blade and a heating device for heating the rotor blade, is proposed. The surge protector, or respectively the spark gap, is prepared to create the coupling in such a way that galvanic isolation will be provided for as long as no lightning strikes the rotor blade and so that the surge protector or respectively spark gap is passed or respectively skipped by the electric current, i.e., that an electric sparkover is achieved, if, through a lightning strike into the rotor blade, namely in particular into the lightning protection system, an electric current is induced in the heating device. Thus, during normal operation, the spark gap prevents a galvanic connection. For the case of a lightning strike, the surge protector or respectively the spark gap is dimensioned in such a way that the voltage occurring in such a case can lead to a sparkover. Thus, the surge protector or respectively the spark gap is dimensioned in such a way that the normal heating operation, where the heating device is supplied with electrical power for heating, does not lead to a sparkover at the spark gap. At the same time, however, the spark gap or another surge protector has to be dimensioned in such a way, and, in particular, comprise such a small distance, that in the case of the voltage induced by a lightning strike, a sparkover can take place before such voltage reaches a voltage level that is jeopardizing the heating device.

Preferably, the surge protector is designed in an encapsulated way, in particular as a module, so that in the case of a lightning strike and a resulting voltage sparkover in the surge protector, the danger of a fire or explosion for the elements surrounding the surge protector is prevented and the surge protector can be removed from the rotor blade (1) and/or installed into the rotor blade (1) from the outside. In the case of a lightning strike, high voltages and/or high power, the influence of which on the surrounding elements, in particular on the rotor blade shell or other elements of the rotor blade, can be destructive and is prevented, or at least limited, by the proposed encapsulation, can occur at the surge protector for a short time. Thus, explosions in the rotor blade, for example, can be prevented, which otherwise could occur due to such a voltage sparkover.

According to one embodiment, the surge protector is designed as a spark gap comprising a receptor and a spark pin. The receptor is connected to the lightning protection system and creates a galvanic connection to it. Thus, lightning can strike the receptor and then reach the lightning protection system through it. The spark pin is connected to the heating device and is ground insulated against the receptor. A spark distance between the receptor and the spark pin is defined and selected in such a way that it determines a sparkover voltage, namely the voltage at which a spark sparks over between the spark pin and the receptor. Thus, this sparkover voltage can be determined through the distance between the spark pin and the receptor, i.e., the spark distance. Preferably, the spark distance is adjustable. Thus, on the one hand, adjustments can be made during the installation and, on the other hand, an adjustment can also be made if the distance has changed, for example due to sediments. Such a distance between the spark pin and the receptor can also be determined in another way and no pin needs to be used for this either, but another shape, for example a ball surface, can be chosen as well.

Preferably, the receptor is permanently connected to the spark pin, or at least one insulator. Thus, the spark gap and the receptor can form a fixed unit together with the insulator and, if applicable, further elements. Preferably, they are designed as a module so that they, i.e., this module, can be removed from the rotor blade or integrated into the rotor blade from the outside. Especially in the case of a lightning strike, and a resulting sparkover between the spark pin and the receptor, this may influence the sparkover voltage. If need be, the distance between the receptor and the spark pin has to be set, a cleaning performed and/or something at this spark gap repaired. For this purpose, such a module can be removed for repair or to integrate a replacement module.

According to one embodiment of the invention, a method for configuring a heating device, includes wherein
the heating device has electrically conductive heating wires and
the heating wires run in a sinusoidal, wave-like and/or zigzag-shaped way, with
an amplitude, defining a sinusoidal amplitude, wave height or respectively spike height, and
a wavelength defining a period length, wavelength or respectively a distance between spikes, wherein
the amplitude and/or wavelength varies along the heating wires in order to be able to adjust the specific areal heating performance of the heating device for each section, wherein

the heating device is divided into several heating sections and, for each section, the amplitude, wavelength and a distance between heating wires are selected in such a way that, with a predetermined heating current, a specific areal heating performance, intended for the respective heating section, will be achieved.

Thus, the design of the heating device for a rotor blade is performed in such a way that the amplitude and the wavelength as well as the distance between neighboring heating wires are systematically used in order to set the specific areal heating performance desired or identified as necessary. Thus, through these three parameters, further influencing factors can be taken into account, such as the respective size of the installation, which can already be accommodated for by heating wires that are arranged in a narrower manner, i.e., with a smaller distance between each other.

In addition, according to one or more embodiments of the invention, a heating device is proposed, which is designated for heating a rotor blade of a wind power installation and designed as described above in the context of the description of at least one embodiment of the rotor blade.

In addition, according to another embodiment of the invention, a method for heating a rotor blade is proposed. Preferably, this method uses one such heating device and is applied to a rotor blade in accordance with at least one of the above described embodiments. For this, the heating device is supplied with a current in order to warm up the heating device and thus at least a part of the rotor blade in the area of which the heating device is arranged. This supply with a current takes place when the occurrence of icing on the rotor blade has to be assumed or expected. Icing has to be expected particularly in the respective weather conditions, namely temperatures around the freezing point and a respective humidity and also in a respective range of wind velocity. In addition, or instead, the existing occurrence of icing can also be detected, for example visually or due to the behavior of the wind power installation, to only name a few examples.

Furthermore, a discharge of an induced voltage takes place in the case of a lightning strike. If, in case lightning strikes the lightning protection system of the rotor blade, a voltage in the heating device is induced due to this lightning strike, it will be discharged through at least one spark gap in the direction of the lightning protection system and/or directly into a grounded wire. Furthermore, the proposed method works as described above in the context of at least one embodiment of a rotor blade.

### BRIEF DESCRIPTION OF THE SEVERAL VIEWS OF THE DRAWINGS

The invention is described in more detail below by embodiments as examples with reference to the accompanying figures.

FIG. 1 shows a rotor blade according to an embodiment of the invention.

FIG. 2 shows an embodiment of a spark gap.

FIG. 3a shows a perspective view of a section of a rotor blade according to an embodiment of the invention.

FIG. 3b shows a schematic sectional view of a rotor blade according to an embodiment.

FIG. 4a shows a heating device and thus a carbon fiber heating system according to an embodiment of the invention.

FIG. 4b shows a heating device divided into a first and a second section.

FIG. 4c shows the schematic view of a heating device in accordance with FIG. 4b, wherein, for illustration purposes, individual heating groups are represented as separate elements.

FIG. 5 shows a schematic view of a perspective illustration of a wind power installation.

### DETAILED DESCRIPTION

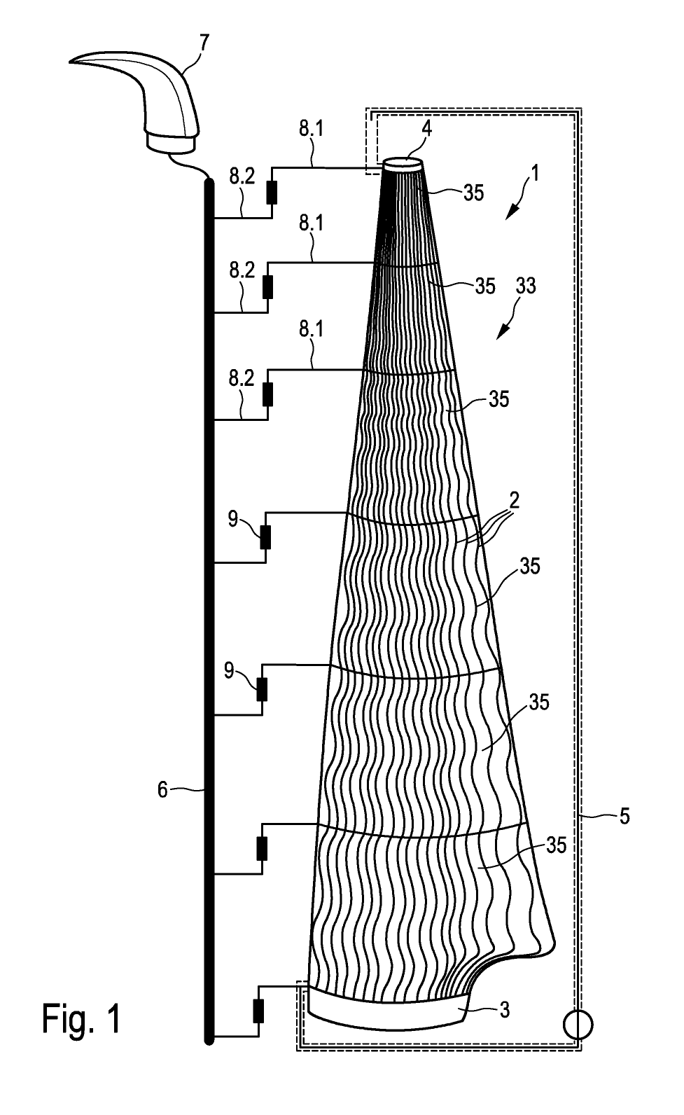

FIG. 1 shows a schematic view of a rotor blade 1 according to one embodiment of the invention, which, along its longitudinal axis, is interspersed with carbon fiber strings 2. These are integrated in the form of a sine wave oscillating in parallel to the blade surface. The amplitude of the sine wave decreases from the blade root 3 to the blade tip 4. Since the circumference of the blade decreases towards the blade tip, there, the strings are closer together than at the blade root. Thus, the energy input increases relative to the blade surface. This is an advantage, since, during operation, the blade tip moves at a higher true velocity than the blade root, and, therefore, is more prone to icing. The electric circuit is closed by a wire 5, which is only schematically indicated in this figure.

Thus, the specific areal heating performance is necessarily increased due to the closer arrangement of the heating wires, namely the carbon fiber strings 2. That is, the area of the rotor blade that is heated increases. By choosing a respective wavelength, the desired specific areal heating performance can be set nevertheless.

It is also visible that in the motion direction of the rotor blade, i.e., transverse to the longitudinal direction of the rotor blade 1, the specific areal heating performance can be influenced by changing the distance between the heating wires 2. Thus, the specific areal heating performance can be varied in the longitudinal direction of the rotor blade, namely by choosing the wavelength and amplitude, as well as in transverse direction to the longitudinal axis of the rotor blade, namely in the direction of the motion, by choosing the respective distances between the heating wires, in particular the carbon fiber strings.

Moreover, FIG. 1 shows a division of the heating device 33 into heating groups 35, namely six heating groups 35 in the illustrated example. Each heating group 35 has several heating wires 2, namely carbon fiber strings 2, which, in each of the heating groups 35, are connected in parallel to each other. The heating groups 35, however, are connected to each other in series. The blade root 3 and the blade tip 4 each have an electric node, in which the heating wires 2 are respectively electrically connected. Thus, this blade root 3 and the blade tip 4 constitute the outer ends of the heating device 33, or respectively a start and an end.

Since the carbon fiber strings 2 are conductive, they constitute a potential target for lightning strikes. Therefore, it is reasonable to connect them to the lightning protection system 6 of the blade, which is also only illustrated schematically in this figure. Usually, the lightning protection system 6 is arranged within the blade, from a metal top of the blade tip 7 to the blade root 3. The carbon fiber strings are connected via wires 8 to the lightning protection system 6 at regular intervals along the longitudinal axis of the blade. In order to not short-circuit the electric circuit during heating operation, the wires 8 are provided with a spark gap 9.

However, in case of a lightning strike, lightning should be prevented from actually striking the carbon fiber strings 2, since this would probably lead to a destruction of the carbon fiber strings 2. Nevertheless, the lightning strike may lead to high power in the lightning protection system 6 and therefore induce a voltage in the carbon fiber stings 2 and thus, in any case, also in the individual heating groups 35. Therefore, each heating group 35 is connected to the lightning protection system 6 via two spark gaps 9. Thus, such a voltage induced by a lightning strike is discharged for each heating group 35 via the respective spark gaps 9.

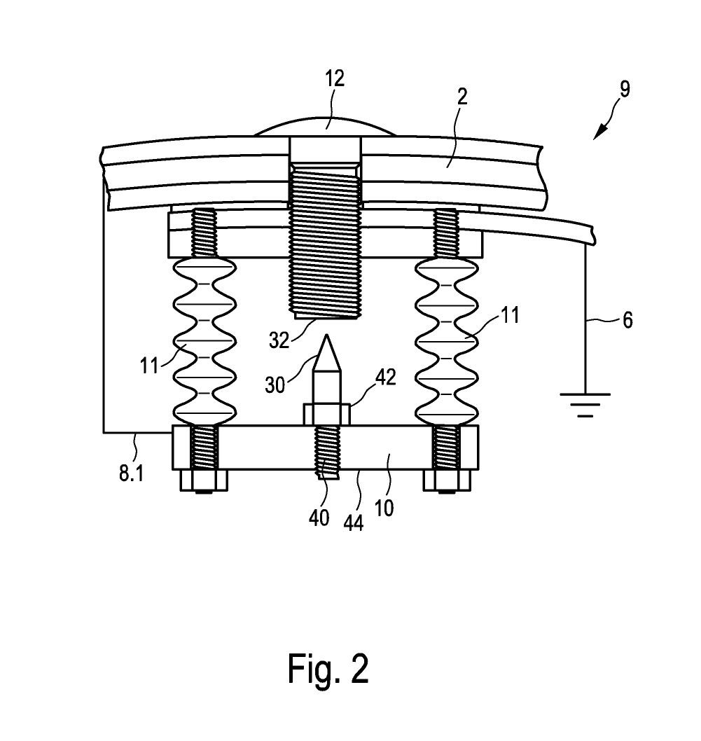

FIG. 2 shows a possible embodiment of the spark gap. The carbon fiber string 2, which, in this case, represents several carbon fiber strings 2 connected in parallel, is galvanically connected via wire 8.1 to the pin element 10, which comprises a spark pin 30, which is located at a predefined distance from an opposite area 32 of the lightning receptor 12, or respectively can essentially adjust the distance. For this, an adjustment screw 40 and an adjustment nut 42 are provided. Thus, the spark pin 30 can be screwed into the base 44 of the pin element 10 for the desired distance, and this position can be fixed through the adjustment nut 42.

The pin element 10 is kept at a distance from the lightning receptor 12 by the electrical insulators 11. The metal lightning receptor 12 breaks through the surface of the rotor blade 1 and serves for the attraction and targeted reception of lightning strikes. It is connected to the grounded lightning protection system 6.

If lightning strikes the lightning protection system 6 and, in doing so, generates a voltage at the carbon fibers strings 2 or respectively at at least one heating group 35, the voltage between the pin element 10 and the lightning receptor 12 will increase so much that a sparkover between these elements will occur. During normal heating operation, however, a sparkover does not occur. Thus, during heating operation, the power which is supplied to the heating device for heating is not discharged.

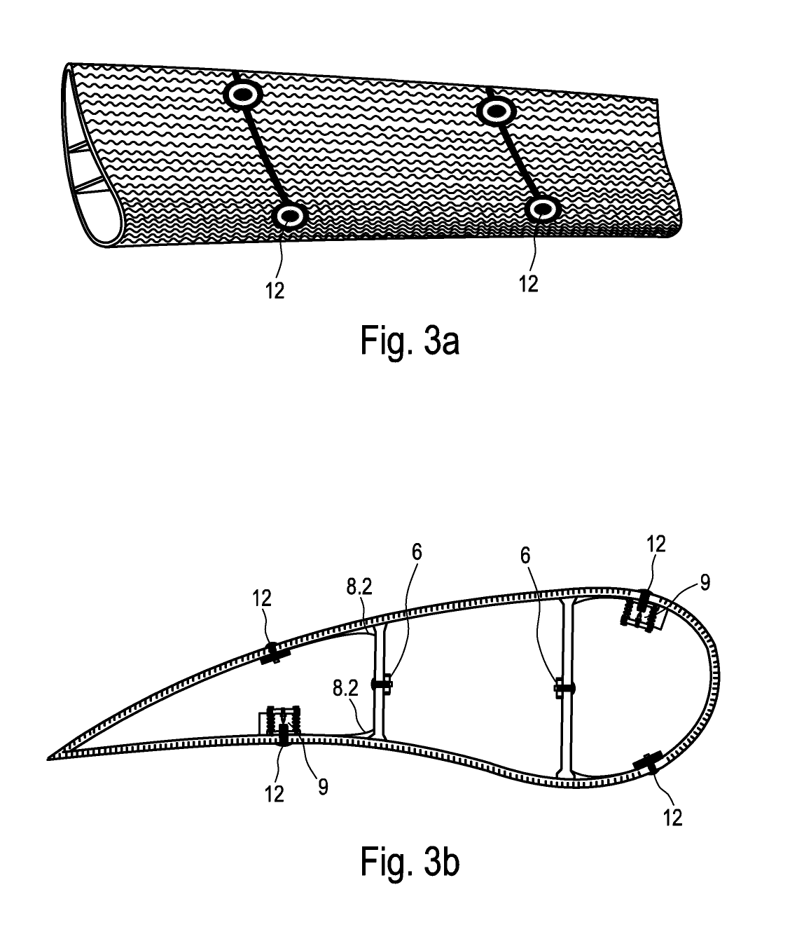

FIG. 3a shows the lightning receptors 12 on the blade surface. These lightning receptors can also be used without being integrated into the spark gap 9, as shown by FIG. 3b for two of four of the lightning receptors 12.

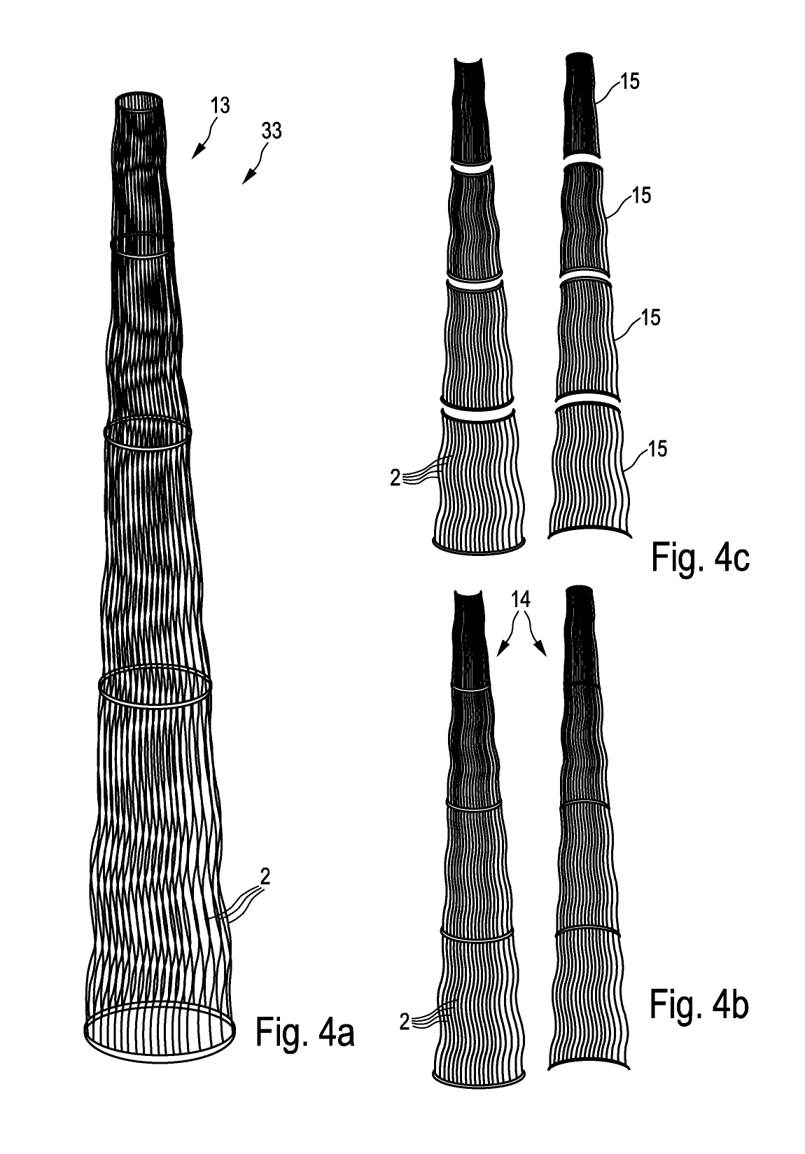

FIGS. 4a, 4b and 4c illustrate embodiments of a heating device 33, which can also be referred to as carbon fiber heating system 13. This heating device 33, or respectively the carbon fiber heating system 13, is to be integrated into a fiber-reinforced plastic structure of a rotor blade, wherein FIGS. 4a, 4b and 4c show the heating device 33 or respectively the carbon fiber heating system 13 without the rotor blade.

Preferably, two half-shells, which are indicated as half-shells 14 in FIG. 4b, are used for manufacturing a rotor blade and, thus, also for manufacturing a carbon fiber heating system 13 or respectively a part thereof. Regarding these half-shells, again, only the elements of the heating device are shown. These half-shells 14 comprise respective carbon fiber strings 2. During the manufacturing of the blade, they are placed into the corresponding half-shells of the blade or respectively into the respective molds for producing the half-shells of the blade and are, in particular, impregnated with the same resin in order to be integrated into the half-shell. In turn, in longitudinal direction, each of the half-shells 14 is divided into elements 15, which respectively form one heating group. This simplifies inter alia the manufacturing. In addition, through this, a connection as shown in FIG. 1 via the wires 8.1 and 8.2 and the spark gap 9 can be realized.

Then, the half-shells 14 can be put together and can be connected together, as indicated in FIG. 4a, or they can be connected in an electrically separate manner or respectively in series, for example through the creation of a connection in the area, which is to be located at the blade tip 4, and the establishment of a connection to a supply voltage in the area, that is to be located at the blade root 3.

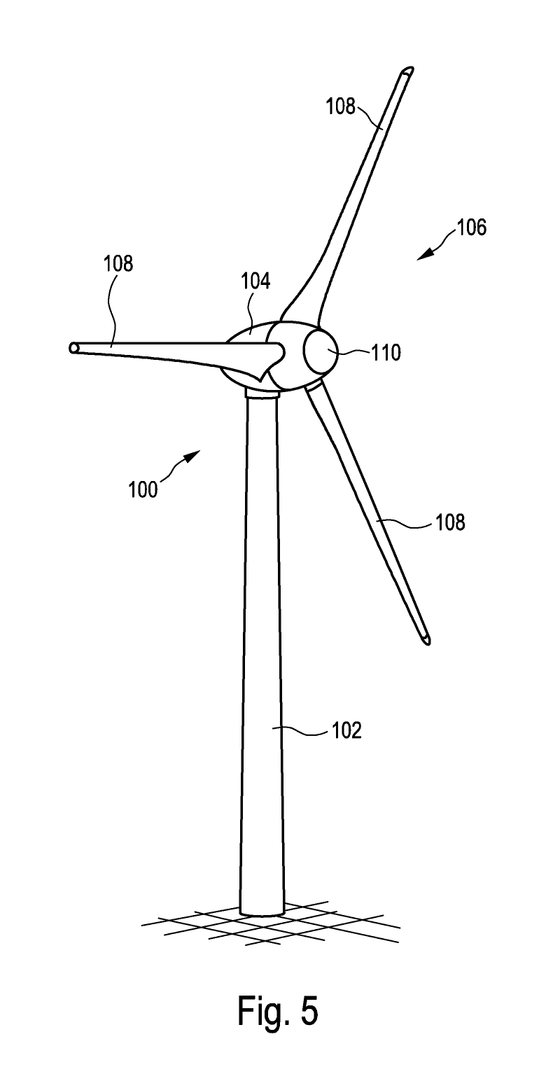

FIG. 5 shows a wind power installation 100 with a tower 102 and a nacelle 104. A rotor 106 with three rotor blades 108 and a spinner 110 is located on the nacelle 104. The rotor 106 is set in operation by the wind in a rotating movement and thereby drives a generator in the nacelle 104.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A rotor blade of a wind power installation comprising:
a body having an inner surface and an outer surface; and
a heating device arranged in the body of the rotor blade or on the inner surface of the body, the heating device configured to heat the rotor blade, the heating device having electrically conductive heating wires that are arranged in a sinusoidal, wave-like or zigzag-shaped way and have an amplitude defining a sinusoidal amplitude, wave height, or spike height, respectively, and a wavelength defining a period length, wavelength, or a distance between spikes, respectively, wherein at least one of the amplitude and wavelength varies along the heating wires to adjust the specific areal heating performance of the heating device on the body.

2. The rotor blade according to claim 1, wherein the amplitude and the wavelength, respectively, are arranged in directions that are parallel to one of the inner or outer surfaces of the body.

3. The rotor blade according to claim 1, wherein the heating wires extend along a longitudinal length of the body of the rotor blade.

4. The rotor blade according to claim 1, wherein the heating wires are integrated into the body of the rotor blade as carbon fibers or carbon fiber roving.

5. The rotor blade according to claim 1, wherein:
the heating wires are divided into heating groups, each including a plurality of heating wires connected together in parallel, and
two or more heating groups are connected with each other in series.

6. The rotor blade according to claim 5, wherein in each heating group, the plurality of heating wires have at least one of different amplitudes, different wavelengths, and different distances between neighboring heating wires in a neighboring heating group.

7. The rotor blade according to claim 5, wherein:
the rotor blade includes an electrical lightning protection system for discharging a lightning strike, and
surge protectors coupling portions of the heating device to the lightning protection system, the surge protectors including spark gaps, respectively, that causes a galvanic isolation to exist when lightning has not yet struck the rotor blade, and the spark gaps are skipped by the electric current when lightning strikes the rotor blade and an electric current is induced in the heating device.

8. The rotor blade according to claim 7 wherein the surge protectors are located at opposing ends of the heating device and between each heating group, respectively.

9. The rotor blade according to claim 1 wherein the body has
a blade root at a first end and a blade tip at a second end, and the heating device is located in a first section that extends from the blade root to the blade tip and in a second section that extends from the blade tip to the blade root, and
wherein the first and second sections are electrically connected in series and in an area of the blade root are connected to a power supply for supplying electrical power for heating to the heating device.

10. A wind power installation comprising:
a rotor; and
a rotor blade including:
a body having an inner surface and an outer surface; and
a heating device arranged in the body of the rotor blade or on the inner surface of the body, the heating device configured to heat the rotor blade, the heating device having electrically conductive heating wires that are arranged in an oscillating manner about a central axis and have an amplitude and a period length, wherein at least one of the amplitude and period length varies along the heating wires to adjust an areal heating performance of the heating device on the body.

11. A surge protector for creating a coupling between an electrical lightning protection system of a rotor blade and a heating device for heating the rotor blade, the surge protector comprising:
a lightning receptor; and
a spark pin coupled to the heating device and spaced apart from lightning receptor by a spark gap, wherein the surge protector causes a galvanic isolation to exist as long as no lightning strikes the rotor blade, and the spark gap is passed or skipped by electric current induced in the heating device in response to lightning striking the rotor blade.

12. The surge protector according to claim 11, wherein the surge protector encapsulated as a module so that in response to the lightning strike and a resulting voltage sparkover in the surge protector, danger of a fire or explosion around the surge protector is prevented, and wherein the surge protector is removeable from the rotor blade and configured to be installed into the rotor blade from the outside.

13. The surge protector according to claim 11 wherein:
the receptor establishes a galvanic connection to the lightning protection system,
the spark pin establishes a galvanic connection to the heating device, and
the spark gap determines a sparkover voltage at which a spark sparks over between the spark pin and the receptor, and wherein the spark gap is adjustable.

14. A method of making a heating device for a rotor blade, the method comprising
forming electrically conductive heating wires into oscillating shapes having amplitudes and period lengths, wherein the oscillating shape is one of sinusoidal, wave-like and zigzag-shaped, and wherein the amplitude defines a sinusoidal amplitude, wave height or spike height, respectively, and a wavelength defines a period length, wavelength or a distance between spikes, respectively,
wherein the forming comprises varying at least one of the amplitude and wavelength along a length of the heating wires thereby adjusting an areal heating performance of the heating device, and
dividing the heating device into a plurality of heating sections and, wherein for each section, the amplitude, the wavelength and a distance between heating wires are selected in such a way that different areal heating performances are achieved.

15. A heating device for heating a rotor blade of a wind power installation, wherein the heating device was formed using a method according to claim 14.

16. A method for heating a rotor blade, the method comprising:
supplying power to heat electrically conductive heating wires that are arranged in a sinusoidal, wave-like or zigzag-shaped way and have an amplitude defining a sinusoidal amplitude, wave height, or spike height, respectively, and a wavelength defining a period length, wavelength, or a distance between spikes, respectively, wherein at least one of the amplitude and wavelength varies along the heating wires, wherein heating the heating wires heats a rotor blade that holds the heating wires.

17. The method according to claim 16, further comprising:
in response to lightning striking the rotor blade, discharging a voltage induced by the lightning in a lightning protection system located on the rotor blade and coupled to the heating wires.

18. The rotor blade according to claim 1 wherein the specific areal heating performance of the heating device is adjusted in sections along the longitudinal length

19. The wind power installation according to claim 10 wherein the heating wires oscillate in one of a sinusoidal, wave-like or zigzag matter about the central axis.
